(19) United States
(12) Patent Application Publication
(10) Pub. No.: US 2008/0138853 A1
(43) Pub. Date: Jun. 12, 2008

(54) Method for evaluating the degree of maturity of corneocytes

(76) Inventors: Tetsuji Hirao, Yokohama-sh (JP); Mitsuhiro Denda, Yokohama-shi (JP); Motoji Takahashi, Yokohama-shi (JP); Tadashi Terui, Sendai-shi (JP); Hachiro Tagami, Sendai-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/987,872

(22) Filed: Dec. 5, 2007

Related U.S. Application Data
(62) Division of application No. 10/380,986, filed on Mar. 20, 2003, now abandoned.

(51) Int. Cl. G01N 1/30

(52) U.S. Cl. 435/40.5

(57) ABSTRACT

Disclosed is an evaluating method for the properties of a corneocyte in a horny layer sample originating in the skin. In the above method, detected and evaluated are selective staining of a cornified envelope in a corneocyte, selective staining of a nuclear component and the antigenicity.

### TECHNICAL FIELD

The present invention relates to a method for evaluating the degree of maturity of a corneocyte constituting a horny layer of the skin. More specifically, the present invention relates to a method for evaluating a skin quality, which is useful in the field of a making-up method or a dermatology and to a kit used for the above evaluating method.

### BACKGROUND ART

It is important in taking precise skin care for maintaining the healthier skin to accurately grasp the skin quality (or the condition of the skin). Accordingly, the skin quality of users of cosmetics has so far been evaluated through, for example, an inquiry made by a beauty technician in carrying out skin care by cosmetics. Further, the condition or function of the skin has so far been evaluated by parameters observed or measured by means of various measuring equipments for the purpose of objectively evaluating the skin quality.

The representatives of such parameters include a skin surface morphology in which the replica of a skin surface is enlarged to observe skin-groove and skin-ridge, a horny layer moisture content obtained by measuring a conductance of a horny layer and a horny layer barrier function obtained by measuring a transepidermal water loss (TEWL).

Further, being applied as an index of a moisturizing capacity of a horny layer are a method in which natural moisturizing factors (NMF, to be specific, various free amino acids) is quantitatively determined and a method in which a skin quality is evaluated by quantitatively determining cytokine in a horny layer. A horny layer is constituted from a corneocyte formed from a cornified epidermal cell which is subjected to terminal differentiation and intercellular lipids surrounding it. It has become apparent that intercellular lipids form a lamella structure comprising components such as ceramides, cholesterol and fatty acids and that it plays an important role in a horny layer barrier function. This is supported by that intercellular lipids are disturbed in terms of morphology and constitution in the case where brought about are various skin diseases caused by a reduction in a horny layer barrier function and skin troubles such as rough skin.

On the other hand, a corneocyte is constituted from a keratin fiber as a principal component and a cornified envelop (hereinafter referred as CE) enveloping it. Plural CE precursor proteins which are produced as a cornified epidermal cell is differentiated are cross-linked by enzyme transglutaminases and insolubilized, whereby CE is formed. Further, it is indicated that ceramide is covalently bonded to a part thereof to form a hydrophobic structure, whereby the basis of a lamella structure in an intercellular lipid is supplied, and the base of a horny layer barrier function is formed.

CE can be prepared by boiling a skin tissue or cultured epidermal keratinocytes in a solution containing a surfactant such as sodium dodecylsulfate and a reducing agent such as 2-mercaptoethanol and removing soluble components by means of a centrifugation to obtain an insoluble fraction. The properties thereof can be evaluated by morphologically observing it under a microscope. Michel et al. report that a lot of CE having a fragile structure is present in the depth of a horny layer as compared with the outermost layer of the horny layer (J. Invest. Dermatol 91: p. 11 to 15, 1988). Further, it is reported that fragile CE is observed as well in the outermost layer in the case of psoriasis and foliaceous ichthyosis (Br. J. Dermatol 122: p. 15 to 21, 1990).

Further, a corneocyte brings about formation and maturing of CE, as described above, in a maturing process thereof, and this allows the nucleus to disappear. In inflammatory skin diseases represented by rough skin and psoriasis, when disappearance of the nucleus doses not smoothly proceed and a corneocyte is present in the outermost layer as it is prematured, this has been called parakeratosis. Thus, a method in which parakeratosis is evaluated by detecting a corneocyte having a nucleus has usually been carried out in a wide range. Such evaluation result has so far been used as an index for diagnosis of skin diseases, evaluation of rough skin, curative effects of medicines and improving effects of cosmetics as one useful index. However, what a remaining nucleus means is not necessarily distinct, and it has not yet scientifically been explained particularly in relation to a barrier function.

### DISCLOSURE OF THE INVENTION

The present inventors have been repeating researches paying attentions to a horny layer barrier function, particularly the relation of CE to intercellular lipids which is considered to mainly constitute barrier function to prevent water evaporation from the body and invasion of foreign substances from the outside and the properties of CE. It has been confirmed that evaluation of a corneocyte suitably prepared causes acquisition of hydrophobicity of CE and a change in disappearance of antigenicity as CE is matured. Further, a method for evaluating appearance of a nucleated cell in a horny layer which has so far widely been used as an index for parakeratosis and a change in CE antigenicity at the same time using a corneocyte suitably prepared has been established to confirm that the state of the skin can more finely be classified by adding the evaluation of appearance of a nucleated cell to the evaluation of the CE antigenicity. The present invention is based on such knowledge.

Accordingly, provided according to the present invention is a method for evaluating the properties of a corneocyte in a dispersion of the corneocyte prepared from a horny layer sample originating in the skin.

Such evaluating method is characterized by:

(A) staining a cornified envelope in the above corneocyte with a coloring material which can selectively stain a hydrophobic area thereof to assume a staining property of the above cornified envelope as an index for evaluation or
(B) detecting an antigenicity of structural proteins for the cornified envelope in the above corneocyte to assume the detected antigenicity as an index for evaluation or
(C) combining the index according to the above (A) or the index according to the (B) or staining either one or both of these indices and a nuclear component in the above corneocyte with a coloring matter which can selectively stain them to evaluate an appearing frequency of a nucleated cell in the above corneocyte and combining the results thereof.

Further, according to the present invention, a kit conveniently used for the evaluating method described above is provided as well.

### BRIEF DESCRIPTIONS OF THE DRAWINGS

FIG. 1 is a photograph (A) obtained by observing under a fluorescent microscope in place of a drawing showing the situation of a tissue cell obtained by subjecting CE in a corneocyte prepared from the face of a person suffering from rough skin to involucrin immunostaining (FITC labeling) and Nile Red staining and a phase contrast image (B). A part pointed by a white frame triangle shows an involucrin-positive immature CE, and a part pointed by a white-coated triangle shows a Nile Red positive mature CE.

FIG. 2 is a photograph obtained by observing under a fluorescent microscope in place of a drawing showing the situation of a tissue cell obtained by subjecting CE prepared from experimental rough skin on the inside of an upper arm of a healthy subject by SDS treatment or repeated tape stripping replacement to involucrin immunostaining (FITC labeling) and Nile Red staining. (A) is the observed result of an control part; (B) is the observed result of a rough skin part induced by SDS; and (C) is the observed result of a rough skin part induced by tape stripping. A part pointed by a white frame triangle shows an involucrin-positive immature CE. Immature CE which is not observed in a healthy part appears in the rough skin part.

In FIG. 3, the photograph of a fluorescent observed image according to Example 3 is shown in an upper drawing, and the photograph of a phase contrast image is shown in a lower drawing. In the photographs, (A) shows a corneocyte of an involucrin (−) nucleus (−); (B) shows a corneocyte of an involucrin (+) nucleus (−); (C) shows a corneocyte of an involucrin (+) nucleus (+); and (D) shows a corneocyte of an involucrin (−) nucleus (+).

### BEST MODE FOR CARRYING OUT THE INVENTION

A horny layer sample originating in the skin in which the properties of a corneocyte or CE are evaluated according to the present invention may be a sample originating in any part of the body and may be cultured materials of such sample (tissue or cell). A cheek and a forehead of a face, a back of a hand and a trunk can be given as the typical examples of a part or an area of the body in which the above sample originates.

Such sample may be obtained by an invasive method such as a so-called surgical means, but when it has a purpose of evaluating the skin quality, it is preferably obtained from the skin by a non-invasive method. Tape stripping and an abrasive method which are usually used in the technical field concerned can be given as the non-invasive method.

Any coloring materials can be used as the coloring matter which can selectively stain a hydrophobic area (particularly biological tissue) of CE as long as they are coloring materials used for staining various hydrophobic areas and meet the purpose of the present invention. Nile Red, Oil Red O and Sudan III can be given as the typical ones of such coloring materials. In particular, Nile Red can suitably be used. Nile Red may be a mixture with Nile Blue which is a reducing type thereof. Included in such mixture are matters of a situation in which a part of Nile Blue is spontaneously oxidized in an aqueous solution of Nile Blue and converted into Nile Red.

On the other hand, any coloring materials can be used as the coloring materials which can selectively stain a nuclear component in a corneocyte as long as they meet the purpose of the present invention. Capable of being used as the specific examples of such coloring materials are fluorescent coloring materials such as propidium iodide, ethydium bromide, Hoechst 33258, acridine orange and SYBR Green and coloring materials such as hematoxylin, Methyl Green and a Methylene Blue-Rhodamine B (3:1) mixed solution. In particular, various fluorescent coloring materials can suitably be used for the purpose of detecting a nucleated cell at a good sensitivity.

Proteins such as involucrin, loricrin and filaggrin and isopeptide and pseudoisopeptide which are cross-linking bonds between proteins can be given as proteins which are targets for detecting an antigenicity of a structural protein for CE. Among them, the antigenicities of involucrin, loricrin and filaggrin are suitably detected. These antigenicities can be detected by using antibodies against these proteins or peptides. The detecting method may be any method as long as it is a method by which bonding of the antibodies to the proteins or peptides described above can be detected, and suited are a fluorescent antibody method and an enzyme antibody method which are used for labeling or staining antigenic substances such as an enzyme and a structural protein in a tissue sample. Suitably used as a fluorescent label for the antibody are, for example, fluorescein isothiocyanate (FITC) and tetramethyl-rhodamine isothiocyanate (TRITC). For example, two kinds of the fluorescent labels described above have different fluorescent wavelengths and can be used as well for detecting the antigenicities of two kinds of antigenic substances at the same time in the same sample by double staining. Such case as detected by double staining is included in the detection of the antigenicity according to the present invention.

Further, the corneocyte suspension prepared from the horny layer sample can be subjected in order to staining with the coloring materials which can selectively stain the hydrophobic area described above and staining using the fluorescent label of the antibody described above (called a fluorescent antibody method) or can be subjected in order to staining with the coloring material which can selectively stain the nuclear component described above and staining using the fluorescent-labelled antibody described above. In staining with the coloring matter and staining using the fluorescent-labelled antibody described above, processing using the fluorescent-labelled antibody is preferably allowed to go ahead.

In the fluorescent antibody method, an antibody against an antigen to be detected may be subjected directly to fluorescent labeling and used. In particular, a so-called indirect method in which an antibody against an antibody against an antigen, that is, the second antibody is subjected to fluorescent labeling is preferred from the viewpoint that the detecting sensitivity is high.

According to the evaluating method for the properties of the corneocyte or CE according to the present invention, when involucrin of CE in the horny layer sample can significantly be detected by a detecting method of antigenicity, it means that lipid is not covalently bonded to involucrin up to a significant amount (or distinguishable extent) or that the cross-linking reaction does not sufficiently proceed and the antigenicity is still remained. Thus, CE in the horny layer sample can be evaluated to stay in a premature state. On the other hand, when involucrin can not significantly be detected, covalent bonding of lipid to involucrin is considerably produced or the cross-linking reaction sufficiently goes on, and the antigenicity disappears. Thus, CE can be evaluated to stay in a mature state. Further, when CE stained strongly positively with, for example, Nile Red is detected (or observed) in the horny layer sample, CE can be evaluated to stay in a rigid state. On the other hand, when variety is observed in the staining property brought by Nile Red, it can be evaluated that scattering is present in a CE forming process. The evaluations described above can be applied as well to a CE forming process in cultured epidermal keratinocytes.

On the other hand, for example, when the nuclear component is stained with propidium iodide and the nucleus is detected, it can be evaluated that the disappearance of the nucleus brought by the maturity of the corneocyte does not sufficiently go on. On the other hand, for example, when the nucleus is not detected with propidium iodide, it can be evaluated that the disappearance of the nucleus brought by the maturity of the corneocyte goes on.

It has been observed that the evaluation results described above have a correlation with a skin quality of the skin which the sample for examination originates in (that is, the skin of the examinee). When involucrin-positive CE can be detected in the horny layer sample, for example, as the result of detecting the antigenicity, it can be evaluated that a horny layer barrier function in the detection-targeted part of the examinee is low and that the rough skin is caused.

To add furthermore, when the abnormal CE described above is observed in the corneocyte obtained from the horny layer sample in the evaluation-targeted part and when the maturity of the corneocyte is not satisfactory, it can be evaluated that the possibility to have some skin troubles such as a rough skin is high. The appearing frequency of the abnormal CE and the nucleated corneocyte may usually be turned into a numerical value by counting the number thereof under a microscope or image analysis. The detecting frequency or the appearing frequency of the abnormal CE and the nucleated corneocyte is compared with that of corresponding CE of a human being which is known to have a normal skin.

In addition thereto, it can be compared as well with the detecting frequency of abnormal CE in the CE or the appearing frequency of the nucleated corneocyte originating in the skin before and after subjected to a skin care treatment in the same person. In this case, for example, when the detecting frequency of the abnormal CE or the appearing frequency of the nucleated corneocyte after it is subjected to a fixed skin care treatment is significantly lower than the corresponding detecting frequency or appearing frequency before that, the above skin care treatment can be evaluated to be effective for improving the skin quality. Thus, according to the present invention, the evaluating method of the skin care means provided to the skin is included therein. Application of skin care cream and skin care lotion to the skin can be given as the specific ones of such skin care treatment, but it shall not be restricted to them.

More specific embodiment of the evaluating method for the skin quality according to the present invention comprises the following steps:

(1) a step in which arranged is the horny layer sample originating in the skin in the evaluation-targeted part of the examinee,
(2) a step in which a dispersion of the corneocyte is prepared from the horny layer sample,
(3) a step in which the cornified envelope in the corneocyte is stained with a coloring material which can stain a hydrophobic area thereof to judge the degree of staining,
(4) a step in which the antigenicity of a structural protein in the cornified envelope is subjected to immune staining with an antibody against the above protein to judge the degree of staining and
(5) a step in which the judging results obtained in the steps (3) and (4) described above are compared with the judging results obtained from the corresponding horny layer sample of a person other than the examinee via the same steps as the steps (1) to (4). The steps (3) and (4) can be carried out in a reverse order.

Further, according to the present invention, capable of being carried out as a different method in place of the step (3) described above is a step (3)′ in which the nuclear component in the corneocyte is stained with a coloring material which can stain the nucleus to evaluate or decide the appearing frequency of the nucleated corneocyte.

The step (3) in which the dispersion of the corneocyte described above is prepared is carried out so that the soluble component is removed, preferably thoroughly removed. This step shall not be restricted and can be carried out by incubating under heating until the soluble component is removed using a buffer solution containing a suitable surfactant (for example, sodium dodecylsulfate (SDS)) and dithiothreitol which is usually known also as a reducing agent. Heating can be made up to 100° C.

On the other hand, in carrying out the step (3)′, preferably selected is such condition that the some soluble components in the corneocyte is removed but the nuclear component remains. Such condition is already known in the technical field concerned and can be referred to, for example, Takahashi et al., J. Soc. Cosmet. Chem., 38, 31-28 (January/February 1987). To briefly describe, the step (3)′ described above can be carried out by processing the horny layer sample, if necessary, with a mixture of a surfactant different from SDS in a kind and SDS without using dithiothreitol described above.

According to the present invention, a kit for evaluating a skin quality is provided.

Included in the above kit are a coloring material which can selectively stain the hydrophobic area of the cornified envelope in the corneocyte of the horny layer sample originating in the skin and a reagent selected from the group consisting of antibodies against the structural proteins for the above cornified envelope, and a coloring material which can selectively stain the nuclear component in the corneocyte may be included therein if necessary.

To be typical, included are Nile Red as the coloring material described above, at least one of the antibodies against involucrin or loricrin as the antibody described above and at least one of the fluorescently labelled (by FITC or TRITC) antibodies against these respective antibodies. Further, propidium iodide can preferably be included therein as a coloring material for staining the nuclear component which is an optional component. Commercially available ones can be used as they are for these coloring matters and the respective antibodies.

Included in the kit according to the present invention are, if necessary, an adhesive tape for collecting the horny layer sample, reagents (refer to examples described later) for preparing the dispersion of the corneocyte or the CE from the horny layer sample and an operation manual.

Thus, according to the present invention, particularly the properties of the corneocyte or the CE can be evaluated using the horny layer sample which can be obtained by a non-invasive method, and in turn the state (or quality) of the skin of an examinee can objectively and accurately be evaluated.

The present invention shall more specifically be explained below with reference to examples.

### EXAMPLE 1

### Evaluation of a Horny Layer Sample Obtained Directly from the Skin

### <Collection of Horny Layer Sample and Preparation of CE>

A cellophane adhesive tape was adhered on a face (cheek) and an upper arm of an examinee having skin troubles such as rough skin and immediately peeled off. A Tris-hydrochloric acid buffer solution containing dithiothreitol and sodium dodecylsulfate (SDS) was added to the horny layer adhered to the tape, and the mixture was heated at 100° C. for 10 minutes. Insoluble substances were obtained by centrifugation of 4000×g for 10 minutes. Further, adding and heating of the effluent were repeated three times to thoroughly remove the soluble components. The insoluble substances thus obtained was CE.

### <Staining Example of CE>

Respective CE's in horny layer samples originating in the upper arm inside (non-processed group) of the examinee which was prepared by the method described above, an SDS-induced rough skin group and a tape stripping-induced rough skin group each were dropped on a slide glass, dried by air and then fixed in cold acetone. The samples were hydrated in a Dulbecco's phosphate-buffered saline and then reacted with a mouse anti-human involucrin antibody (NOVOCASTRA Co., Ltd.) used as a primary antibody. After removing the excess antibodies by washing, they were reacted with a FITC-labelled rat anti-mouse immunoglobulin antibody used as a secondary antibody. After removing the excess antibodies by washing, they were reacted with a Nile Red staining solution, sealed and observed under a fluorescent microscope. The observed image was introduced into a computer via a CCD camera and printed, and an image analytical soft (Mac Scope) was used to distinguish involucrin-positive CE and Nile Red positive CE.

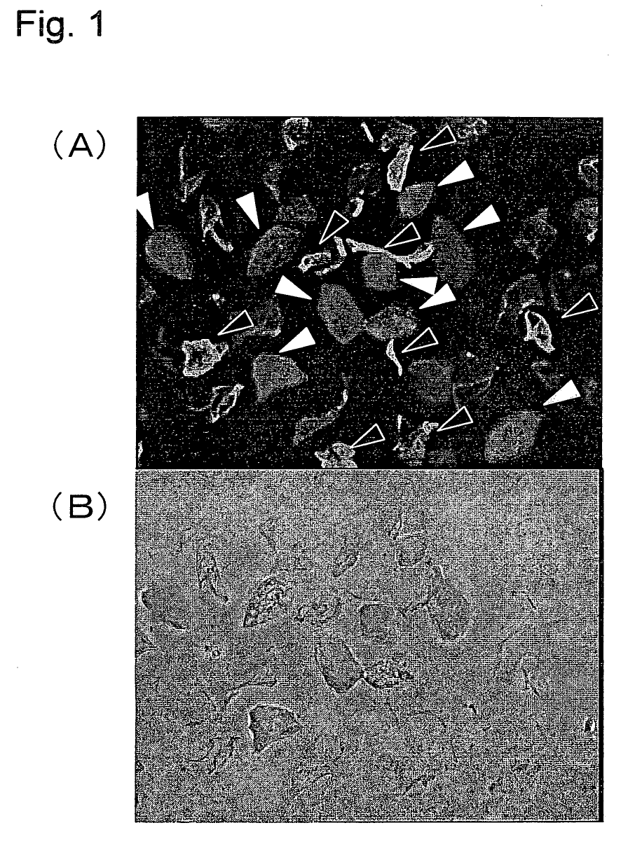

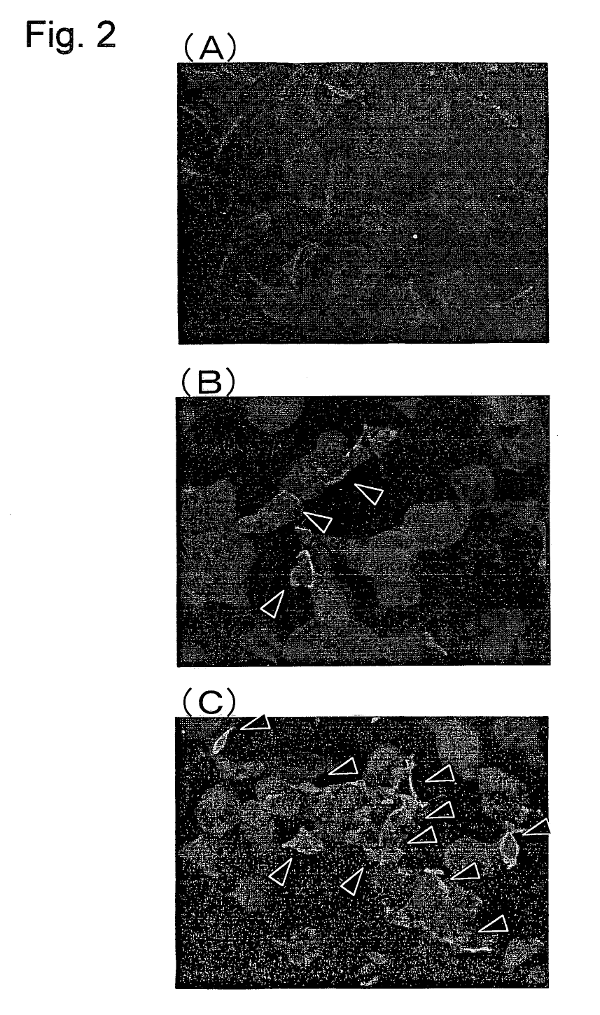

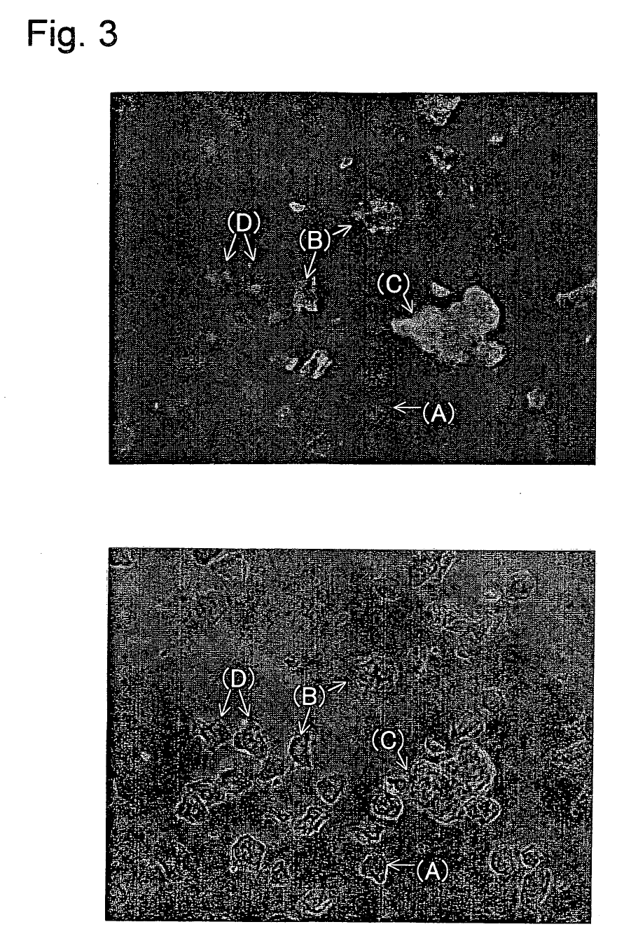

A result obtained by staining CE originating in the face of a person troubled with rough skin in the manner described above is shown in FIG. 1 (drawing substitute photograph), and shown in FIG. 2 (drawing substitute photograph) is a result obtained by staining CE originating in a horny layer obtained by experimental rough skin induced by sodium dodecylsulfate (SDS) processing or tape stripping on inside of upper arm without any skin troubles.

Further, the proportions of the involucrin-positive CE's in the SDS treated group and the tape stripping group in the experimental rough skin described above are shown in Table 1 in comparison with that of the involucrin-positive CE in the non-processed group (each 3 to 4 specimens).

TABLE 1
Increase in involucrin-positive CE in the experimental rough skin

| | Proportion of involucrin- |
|---|---|
| | positive CE (%) |
| Horny layer | average ± SD |
| Non-treated group | 0.09 ± 0.04 |
| SDS-induced rough skin group | 6.21 ± 2.96 |
| Tape stripping rough skin group | 13.12 ± 4.00 |

After staining CE, the fluorescent image was introduced into a computer to calculate the proportion of the involucrin-positive CE from an area of the FITC positive CE in the whole area of CE by means of the image analytical soft Mac Scope.

### EXAMPLE 2

### Evaluation of Cultured Epidermal Keratinocytes

### <CE Formation-Promoting Effect>

A human epidermal keratinocytes were cultured according to a Rheinwald & Green method (Cell: 6: 331-334, 1975). It was cultured in a growth medium (DMEM-Ham's sF 12 (3:1) containing 10% fetal calf serum, hydrocortisone 0.5 μg/ml, insulin 5 μg/ml, cholera toxin 10⁻¹⁰ M, epidermal growth factor 10 ng/ml and adenine 1.8×10⁻⁴ M) and reached confluent, and then the medium was substituted with a culture medium (MEM containing 0.1% bovine serum albumin) containing oleic acid or linoleic acid which is known to urge the differentiation of keratinocite to accelerate the formation of a barrier (Hanley et al., Journal of Clinical Investigation 100: 705-712, 1997 and Komuves et al., Journal of Investigative Dermatology 111: 429-433, 1998). Further, culture was continued for one week. After finishing the culture, a Tris-hydrochloric acid buffer solution containing dithiothreitol and sodium dodecylsulfate (SDS) was added thereto, and the mixture was heated at 100° C. for 10 minutes. Insoluble substances were obtained by centrifugation of 4000×g for 10 minutes. Further, adding and heating of the effluent was repeated three times to thoroughly remove the soluble components. The insoluble substances thus obtained were CE. The CE thus obtained was subjected to anti-human involucrin antibody processing and Nile Red staining according to the method described in the foregoing example. The results thereof are shown in Table 2.

TABLE 2
Decrease in involucrin-positive CE caused
by addition of free fatty acid

| | Proportion of involucrin- |
|---|---|
| | positive CE (%) * |
| Culture medium | average ± SD |
| Growth medium | 15.83 ± 3.49 |
| 100 μM oleic acid added | 0 (not detected) |
| 100 μM linoleic acid added | 0 (not detected) |

${ }^{*} \% = \frac{Involucrin \text{-} positive CE}{involucrin \text{-} positive CE + Nile Red positive CE} \times 100$

### EXAMPLE 3

### Detection of Nuclear Component in Corneocyte

### <Collection of Horny Layer Sample and Preparation of Corneocyte>

The corneocyte was dispersed from the horny layer sample according to the method of Takahashi et al. (described above). That is, a cellophane adhesive tape was adhered on the skin of a part to be examined and immediately peeled off. A sodium dodecylsulfate (SDS)-dodecyldimethylamine oxide (C₁₂DMAO) mixed solution was added to the horny layer adhered to the tape and heated at 50° C. for 24 hours. The dispersed corneocytes were obtained by centrifugation of 4000×g for 10 minutes. Further, they were washed three times repeatedly with the SDS-C₁₂DMAO mixed solution to thoroughly remove the soluble components to thereby prepare the corneocytes.

### <Staining of CE and Nucleus in Corneocyte>

The corneocytes prepared by the method described above were dropped on a slide glass, dried by air and then fixed in cold acetone. They were hydrated in a Dulbecco's phosphate buffered saline and then reacted with a mouse anti-involucrin antibody (NOVOCASTRA Co., Ltd.) used as a primary antibody. After removing the excess antibodies by washing, they were reacted with an FITC-labelled rat anti-mouse immunoglobulin antibody used as a secondary antibody. After removing the excess antibodies by washing, they were reacted with a propidium iodide solution to stain the nucleus, sealed and observed under a fluorescent microscope. The observed image was introduced into a computer via a CCD camera and printed, and the involucrin-positive cells and the nuclear positive corneocytes were identified and counted.

A horny layer was sampled from an involved area and an uninvolved area of psoriasis vulgaris, and the images of the evaluation results described above are shown in FIG. 3. Also, the totalized results are shown in Table 3.

TABLE 3
Evaluation results of corneocytes maturity in psoriasis vulgaris

| | Positive ratio (%) | | | |
|---|---|---|---|---|
| | Mature CE | Immature CE | Immature CE | Immature CE |
| | nucleated | nucleated | non-nucleated | non-nucleated |
| Unin- | 4.45 | 0.65 | 3.90 | 91.00 |
| volved | | | | |
| area | | | | |
| In- | 30.70 | 7.69 | 8.80 | 52.81 |
| volved | | | | |
| area | | | | |

Average of N = 5

It is known that in psoriasis vulgaris, the symptom of titter appears at a limited part and that a barrier function is notably reduced at an involved area and almost normal at an uninvolved area. Accordingly, the presence of the corneocytes in the involved area which are so different respectively that CE is immature or mature and nucleated or non-nucleated suggests the possibility that maturity of CE and disappearance of the nucleus are controlled in different manners respectively. Parakeratosis has so far been evaluated by detecting a nucleated corneocyte, but the evaluating method described in the present specification makes it possible to more finely evaluate parakeratosis.

### INDUSTRIAL APPLICABILITY

According to the present invention, the properties of a corneocyte contained in a horny layer sample originating in the skin, in turn the healthiness of the above corneocyte can be evaluated in details. Accordingly, it can conveniently be used for evaluating a skin quality itself and means applied to the skin in the field of beauty techniques (or beauty business) or dermatology.

1. An evaluating method for the properties of a corneocyte in a suspension of the corneocyte prepared from a horny layer sample originating in the skin, characterized by:
(A) staining a cornified envelope in the above corneocyte with a coloring material which can selectively stain a hydrophobic area of the above cornified envelope to assume a staining property of the above cornified envelope as an index for evaluation or
(B) detecting an antigenicity of structural proteins for the cornified envelope in the above corneocyte to assume the detected antigenicity as an index for evaluation or
(C) combining the index according to the above (A) or the index according to the (B) or staining either one or both of these indices and a nuclear component in the above corneocyte with a coloring material which can selectively stain them to evaluate an appearing frequency of a nucleated cell in the above corneocyte and combining the results thereof.

2. The evaluating method as described in claim 1, wherein only the index according to the above (A) is used.

3. The evaluating method as described in claim 1, wherein only the index according to the above (B) is used.

4. The evaluating method as described in claim 1, wherein the index according to the above (A) and the index according to the above (B) are used.

5. The evaluating method as described in claim 1, wherein either one or both of the index according to the above (A) or the index according to the above (B) is combined with the result of the appearing frequency according to the above (C).

6. The evaluating method as described in claim 1, wherein the coloring material which can selectively stain the above hydrophobic area thereof is Nile Red.

7. The evaluating method as described in claim 1, wherein the antigenicity is detected with an anti-human involucrin antibody.

8. The evaluating method as described in claim 1, wherein the horny layer sample originating in the skin is obtained from the skin by a non-invasive method.

9. The evaluating method as described in claim 1, wherein the horny layer sample originating in the skin originates in cultured epidermal keratinocytes.

10. The evaluating method as described in claim 1, wherein the evaluation is aimed at a maturity of the corneocyte.

11. The evaluating method as described in claim 1, wherein the evaluation is aimed at the evaluation of the skin quality.

12-14. (canceled)
